(19) United States
(12) Patent Application Publication
(10) Pub. No.: US 2026/0351853 A1
(43) Pub. Date: Nov. 5, 2026

(54) ANTENNA MODULE HAVING PHASE DELAY

(71) Applicant: LG ELECTRONICS INC., Seoul (KR)

(72) Inventors: Woocheol CHOI, Seoul (KR); Ilnam CHO, Seoul (KR); Byeongyong PARK, Seoul (KR); Youngtaek HONG, Seoul (KR)

(73) Assignee: LG ELECTRONICS INC., Seoul (KR)

(21) Appl. No.: 19/488,502

(22) PCT Filed: Aug. 31, 2023
(86) PCT No.: PCT/KR2023/013007

§ 371 Date: Nov. 26, 2025

(51) Int. Cl. H01Q 9/04

(52) U.S. Cl. CPC H01Q 9/0414

(57) ABSTRACT

This antenna module comprises: a dielectric substrate; a plurality of antenna elements disposed in one axial direction on one surface of the dielectric substrate, the plurality of antenna elements including first and second antenna elements facing each other; and a stub pattern disposed so as to connect, in the one axial direction, the facing sides of the first and second antenna elements. The stub pattern may comprise: a horizontal stub pattern; and vertical stub patterns that extend perpendicularly in another axial direction from different points of the horizontal stub pattern.

### TECHNICAL FIELD

This specification relates to an antenna module having a phase delay. A particular implementation relates to an antenna module having a phase delay and including an array antenna structure capable of performing beamforming.

### BACKGROUND ART

A phased array antenna may adjust a beam steering direction by electronically controlling a phase of electromagnetic waves at an element level. At this time, the phase control of the electromagnetic waves at the element level is being applied by a phase shifter at a radio frequency stage. However, there is a problem in that such a phase shifter may increase a weight, a size, and a cost of the phased array antenna.

Meanwhile, a series-fed array antenna may be applied to implement an array antenna within a limited region. The series-fed array antenna is designed such that radiators connected to each other in series along a transmission line are arranged to be apart from each other by a gap corresponding to a guided wavelength (λg) to generate an in-phase current distribution. Accordingly, although a high radiation gain may be maintained in a front direction of the array antenna, there is a restriction such that beam-steering may be limited to a single axis direction during beam scanning.

### DISCLOSURE OF INVENTION

### Technical Problem

This specification is to provide an array antenna capable of two-dimensional beam steering by applying a slow-wave structure and a liquid crystal medium.

This specification is to actively controlling a signal transmission phase by changing a parameter of a phase delay circuit in a series-fed array antenna.

This specification is to provide an array antenna with a reduced feed loss in a millimeter wave band.

This specification is to improve wireless communication performance in frequency bands at or above millimeter wave bands by generating a directional beam in a desired direction.

### Solution to Problem

To achieve these and other advantages and in accordance with the purpose of this specification, as embodied and broadly described herein, there is provided an antenna module including: a dielectric substrate; a plurality of antenna elements arranged on one surface of the dielectric substrate in a direction of one axis, the plurality of antenna elements including a first antenna element and a second antenna element arranged to face each other; and a stub pattern configured to connect side surfaces of the first antenna element and the second antenna element in the one axis direction, the side surfaces facing each other.

According to an embodiment, the stub pattern may include a horizontal stub pattern configured to connect the facing side surfaces of the first antenna element and the second antenna element in the one axis direction; and vertical stub patterns arranged to extend from different points on the horizontal stub pattern in a direction of another axis to be perpendicular to the horizontal stub pattern.

According to an embodiment, the antenna module may further include a feeding line connected to one side of an outermost element among the plurality of antenna elements, and configured such that a radio frequency (RF) signal is applied to the outermost element. The RF signal applied through the feeding line may be transmitted to the second antenna element through the first antenna element and the stub pattern.

According to an embodiment, the vertical stub patterns may include a first sub-pattern arranged at a first point of the horizontal stub pattern to have a first length in at least one direction among an upper direction and a lower direction on the another axis; and a second sub-pattern arranged at a second point of the horizontal stub pattern to have a second length to be parallel to the first sub-pattern. The first sub-pattern may be arranged to be adjacent to the first antenna element, and the second sub-pattern may be arranged to be adjacent to the second antenna element.

### Advantageous Effects of Invention

Hereinafter, technical effects of an antenna module having a phase delay are described.

According to an embodiment, two-dimensional beam-steering of an array antenna may be performed by applying a slow-wave structure and a liquid crystal medium to a design of a series-fed array antenna.

According to an embodiment, a signal transmission phase may be actively controlled by implementing a phase shift circuit based on a slow-wave structure in a series-fed array antenna, using a liquid crystal layer, and changing a parameter of a phase delay circuit.

According to an embodiment, a feed loss in a millimeter wave band may be reduced by implementing feeding lines between antenna elements as a serial feeding structure having a slow-wave structure.

According to an embodiment, wireless communication performance may be improved in frequency bands at or above millimeter wave bands by generating a directional beam in a desired direction along one axis direction through a one-dimensional array antenna structure having serial feeding lines.

Further scope of applicability of this specification will become apparent from the following detailed description. It should be understood, however, that the detailed description and specific examples, such as the exemplary embodiment of this specification, are given by way of illustration only, since various changes and modifications within the idea and scope of this specification will be apparent to those skilled in the art.

### BRIEF DESCRIPTION OF DRAWINGS

FIG. 1 illustrates a structure of an array antenna module including a plurality of elements according to this specification.

FIG. 2 illustrates a structure implemented to have a reflective reconfigurable intelligent surface (RIS) and a transmissive RIS according to this specification.

FIG. 3 is an enlarged diagram of an array antenna in which a plurality of antenna elements are arranged in one axis direction and a feeding structure connecting adjacent antenna elements with each other.

FIG. 4 is a cross-sectional view of a partial region of an antenna module of FIG. 3.

FIGS. 5A to 5C illustrate feeding structures including a vertical stub pattern according to embodiments.

FIG. 6 illustrates slow-wave structures according to embodiments.

FIG. 7 shows slow-wave factors according to an impedance ratio in a slow-wave structure according to this specification.

FIGS. 8A to 8C show phase delay characteristics of a feeding structure depending on changes in a dielectric constant and a length of a longest vertical stub pattern according to embodiments.

FIG. 9 shows equivalent circuits of a feeding structure including adjacent stub patterns of FIGS. 6A to 6C.

FIG. 10 shows three-dimensional (3D) radiation patterns when a length of a fourth vertical stub pattern in the antenna module of FIG. 3 is changed.

FIG. 11 shows two-dimensional (2D) radiation patterns when a length of the fourth vertical stub pattern in the antenna module of FIG. 3 is changed.

FIG. 12 shows 2D radiation patterns according to changes in a gap between adjacent antenna elements in the antenna module of FIG. 3.

### MODE FOR THE INVENTION

Hereinafter, an antenna module having a phase delay according to this specification will be described.

In this regard, a module including a plurality of elements according to this specification may be referred to as an array antenna module having a phase delay. The antenna module may be configured to include a plurality of radiators and a phase delay element capable of implementing a phase delay. The phase delay element may also be implemented as a feeding structure of a particular structure without separate electronic components such as a phase shifter.

The array antenna module may be configured to support a sixth-generation (6G) wireless communication service. In this regard, the array antenna module may be configured to operate in a millimeter wave band or in a GHz band. The array antenna module may be applied to a mobile communication antenna, a vehicle antenna, or a satellite communication antenna.

Application of the 6G wireless communication service is not limited to electronic devices such as a mobile terminal or an image display device. The 6G wireless communication service may be applied to electronic devices that support fully-autonomous vehicles, artificial (AI) robots, intelligence and augmented/virtual reality (AR/VR)-based metaverses.

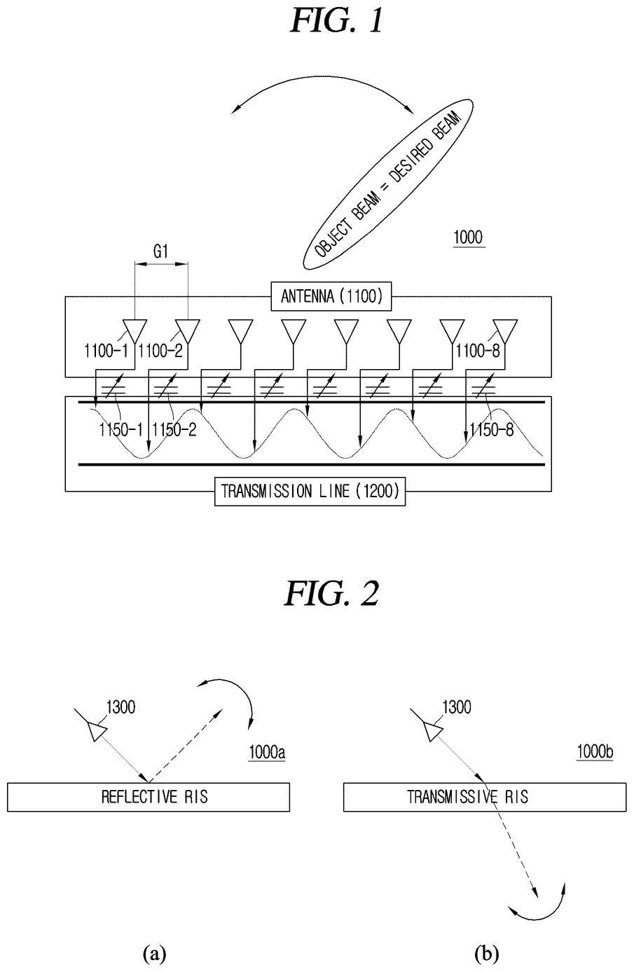

FIG. 1 illustrates a structure of an array antenna module including a plurality of elements according to this specification. Referring to FIG. 1, an array antenna module 1000 may include an array antenna 1100 including a plurality of elements 1100-1 to 1100-8. A number of the plurality of elements is not limited to eight, and may vary depending on an application.

The antenna module 1000 may be configured as a one-dimensional array antenna in which the plurality of elements are arranged in a direction of one axis. As another example, the antenna module 1000 may be configured as a two-dimensional array antenna in which a plurality of elements are arranged in the one axis direction and a direction of another axis perpendicular thereto.

A gap G1 defined between the plurality of elements 1100-1 to 1100-8 may be implemented as a numerical value associated with a wavelength corresponding to an operating frequency. The plurality of elements 1100-1 to 1100-8 may be operably coupled to phase delay elements 1150-1 to 1150-8, respectively. The phase delay elements 1150-1 to 1150-8 may be each configured as a feeding structure having a phase delay. The phase delay elements 1150-1 to 1150-8 may be each configured as a feeding structure connecting adjacent antenna elements.

A transmission line 1200 connected to the plurality of elements 1100-1 to 1100-8 may be implemented as a waveguide, a microstrip line, a strip line, or a substrate integrated waveguide (SIW). Each of the plurality of elements 1100-1 to 1100-8 may be controlled to independently turn on/off. Each of the plurality of elements 1100-1 to 1100-8 may be independently controlled to turn on/off to adjust a beam forming direction of the antenna module 1000.

As the plurality of elements 1100-1 to 1100-8 are independently turned on/off, a phase of a signal applied to each of the plurality of elements 1100-1 to 1100-8 may be varied as shown in the transmission line 1200 of FIG. 1. As an interval between on/off operations of the plurality of elements 1100-1 to 1100-8 decreases, a phase difference between adjacent elements increases. Accordingly, as the interval between the on/off operations of the plurality of elements 1100-1 to 1100-8 decreases, a beam forming angle increases.

Meanwhile, the antenna module including the plurality of antenna elements according to this specification may be combined with a reconfigurable intelligent surface (RIS) to enable phase control. In this regard, FIG. 2 illustrates a structure implemented to have a reflective reconfigurable intelligent surface (RIS) and a transmissive RIS according to this specification.

Referring to (a) of FIG. 2, the antenna module 1000 may be configured to include a reflective RIS 1000a and at least one external antenna 1300. Configuration may be performed such that a wireless signal radiated from the external antenna 1300 is reflected by the reflective RIS 1000a. An on/off state of each element constituting the reflective RIS 1000a may vary independently so that a beam forming angle of the wireless signal is varied.

Referring to (b) of FIG. 2, the antenna module 1000 may be configured to include a transmissive RIS 1000b and at least one external antenna 1300. Configuration may be performed such that a wireless signal radiated from the external antenna 1300 passes through the transmissive RIS 1000b. An on/off state of each element constituting the transmissive RIS 1000b may vary independently so that a beam forming angle of the wireless signal is varied.

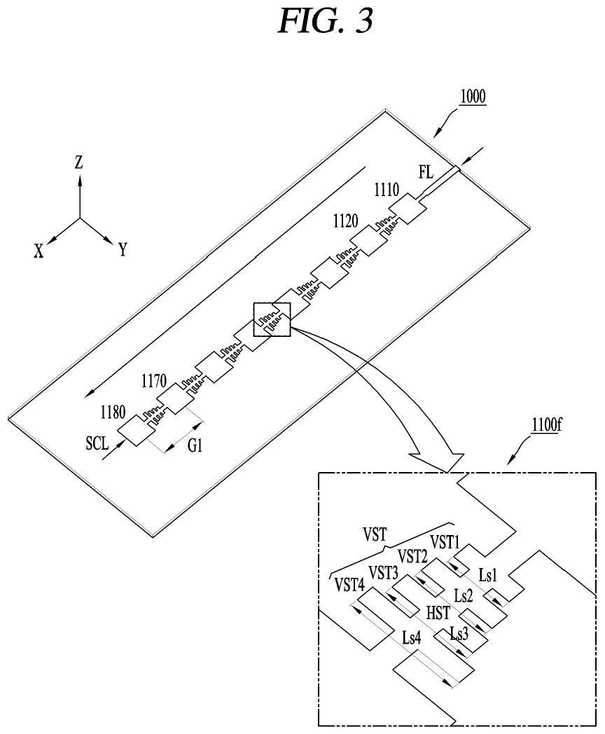

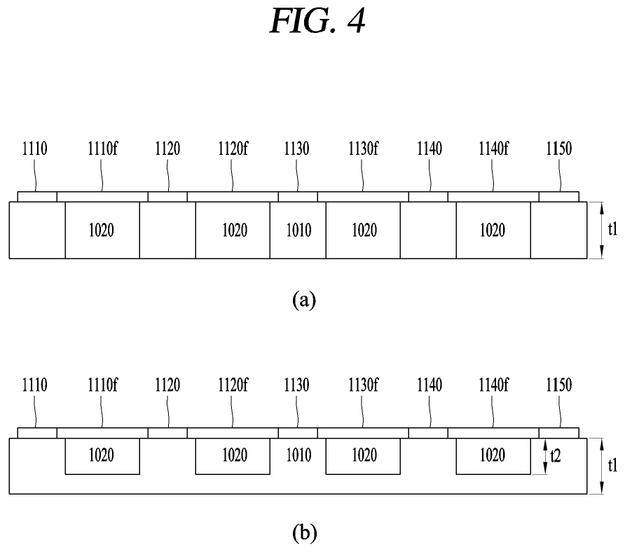

Hereinafter, an antenna module having a phase delay according to this specification will be described. In detail, FIG. 3 is an enlarged diagram of an array antenna in which a plurality of antenna elements are arranged in the one axis direction and a feeding structure connecting adjacent antenna elements with each other. FIG. 4 is a cross-sectional view of a partial region of an antenna module of FIG. 3.

Referring to FIG. 3, the antenna module 1000 may include a dielectric substrate 1010, a plurality of antenna elements, and a stub pattern 1100f. The stub pattern 1100f may be configured to feed the plurality of antenna elements. Accordingly, the stub pattern 1100f may be referred to as a feed pattern or a feeding structure. In this regard, a type of antenna array in which adjacent antenna elements are fed to be connected to each other may be referred to as a series-fed antenna array.

Meanwhile, a series-fed array antenna may be designed to have radiation elements arranged continuously along a direction in which a radio frequency (RF) signal propagates along a transmission line. Adjacent radiation elements are arranged to be apart from each other by a gap corresponding to a guided wavelength (λg) determined in consideration of an effective dielectric constant of the transmission line, and designed such that an in-phase current distribution is generated in all array elements. Therefore, strong electromagnetic waves may be radiated in a normal vector direction of the series-fed array antenna. Meanwhile, in a general series-fed array, since radiation elements are designed with a gap calculated as λg, beam steering/beam forming cannot be performed. When radiation characteristics are to be changed by changing a gap between array elements, since a length of a transmission line connected between the elements is small (<λg/2), characteristics change may not be easily performed.

Therefore, a design technique capable of generating various radiation pattern directivities by applying a slow-wave structure to design of a series-fed array antenna, as shown in FIG. 3, may be proposed. At this time, a number (N−1) that is one less than a number (N) of arranged antennas may be applied to the slow-wave structure. By arranging the slow-wave structure between respective array antennas, a phase constant (φ) delivered to each arranged element may be varied to allow to operate as a circuit configured to vary an array factor of the series-fed array antenna.

This specification is to propose an antenna design method capable of diversifying a radiation pattern directivity of an array antenna using the slow-wave structure. Therefore, through a feeding structure of the slow-wave structure according to this specification, a gap between elements in the array antenna may be adjusted, a beam steering angle may be adjusted, a beam width may be varied, and/or a beam-squint may be improved.

Meanwhile, referring to FIG. 4, a phase constant may be adjusted using liquid crystal layers 1020 having a variable dielectric constant. In this regard, the liquid crystal layers 1020 may be arranged in regions below a plurality of feeding structures 1110f to 1140f arranged on a front surface of the dielectric substrate 1010 in a Z-axis direction. The plurality of feeding structures 1110f to 1140f and a plurality of antenna elements 1110 to 1140 may be arranged on the front surface of the dielectric substrate 1010. A ground layer may be placed on a rear surface of the dielectric substrate 1010. The liquid crystal layers 1020 may be placed in the regions below the first feeding structure 1110f to the fourth feeding structure 1140f.

As a voltage applied to the liquid crystal layers 1020 in the regions below the first feeding structure 1110f to the fourth feeding structure 1140f is changed, an effective permittivity induced by the feeding structures 1110f to 1140f may be changed. Thus, an electrical length of the feeding structures 1110f to 1140f in a direction of a Y-axis may be varied. Accordingly, as a phase difference between the antenna elements 1110 to 1140 arranged between the feeding structures 1110f to 1140f may be varied, a direction angle of an antenna beam may be changed.

Referring to (a) of FIG. 4, a thickness of each of the liquid crystal layers 1020 may be identical to a first thickness t1 of the dielectric substrate 1010. Referring to (b) of FIG. 4, a thickness of each of the liquid crystal layers 1020 may be configured as a second thickness t2 smaller than the first thickness t1 of the dielectric substrate 1010.

Meanwhile, the plurality of antenna elements may be arranged in the one axis direction to constitute the array antenna 1100. The plurality of antenna elements may be arranged on one surface of the dielectric substrate 1010 in the one axis direction. A ground plane may be arranged on another surface of the dielectric substrate 1010 to provide a ground for a plurality of antenna elements 1110 to 1180.

The plurality of antenna elements may include the first antenna element 1110 and the second antenna element 1120 arranged to face each other. The array antenna 1100 may include a plurality of antenna elements such as four, six, eight, ten, twelve, fourteen, or sixteen antenna elements. As one example, the array antenna 1100 may be also configured to include the first array antenna 1110 to the eighth array antenna 1180.

The stub pattern 1100f may be configured to connect side surfaces of the first antenna element 1110 and the second antenna element 1120 to each other, the side surfaces facing each other, in the one axis direction. In the array antenna having the plurality of antenna elements, the stub pattern 1100f may be configured to include a plurality of stub patterns.

In a 1×4 array antenna, the stub pattern 1100f may be configured to include a first sub-pattern 1110f to a third sub-pattern 1130f. The first stub pattern 1110f to the third stub pattern 1130f may be referred to as a first feeding structure to a fourth feeding structure, respectively. The first stub pattern 1110f may be arranged to connect another end of the first antenna element 1110 to one end of the second antenna element 1120. The second stub pattern 1120f may be arranged to connect another end of the second antenna element 1120 to one end of the third antenna element 1130. A third stub pattern 1130f may be arranged to connect another end of the third antenna element 1130 to one end of the fourth antenna element 1140.

In a 1×8 array antenna, the stub pattern 1100f may be configured to include the first stub pattern 1110f to the third stub pattern 1130f each described above and a fourth stub pattern 1140f to a seventh stub pattern 1170f. The first stub pattern 1110f to the seventh stub pattern 1170f may be referred to as the first feeding structure to a seventh feeding structure, respectively. A detailed description of the first stub pattern 1110f to the third stub pattern 1130f has been described in the paragraph above, and thus, will not be provided again. The fourth stub pattern 1140f may be arranged to connect another end of the fourth antenna element 1140 to one end of the fifth antenna element 1150. The fifth stub pattern 1150f may be arranged to connect another end of the fifth antenna element 1150 to one end of the sixth antenna element 1160. The sixth stub pattern 1160f may be arranged to connect another end of the sixth antenna element 1160 to one end of the seventh antenna element 1170. The seventh stub pattern 1170f may be arranged to connect another end of the seventh antenna element 1170 to one end of the eighth antenna element 1180.

The stub pattern 1100f may include a horizontal stub pattern HST arranged in the one axis direction and a vertical stub pattern VST arranged in the another axis direction perpendicular to the one axis direction.

The horizontal stub pattern HST may be arranged to connect side surfaces of the first antenna element 1110 and the second antenna element 1120, the side surfaces facing each other, in the one axis direction. The vertical stub pattern VST may be arranged to extend from different points on the horizontal stub pattern HST in the another axis direction to be perpendicular to the horizontal stub pattern HST.

The antenna module 1000 may further include a feeding line FL. In addition, the antenna module 1000 may further include a signal connection line SCL. The feeding line FL may be connected to one side of an outermost element 1110 among the plurality of antenna elements, and configured such that an RF signal is applied to the outermost element 1110.

The signal connection line SCL may be connected to another side of an outermost element 1180 among the plurality of antenna elements and configured such that a direct current (DC) voltage is applied to the outermost element 1180. The outermost element 1110 to which the feeding line FL is connected corresponds to the first antenna element located in a rightmost region. The outermost element 1180 to which the signal connection line SCL is connected corresponds to the eighth antenna element arranged in the rightmost region. An RF signal applied through the feeding line FL may be transmitted to the second antenna element 1120 through the first antenna element 1110 and the stub pattern 1100f.

As described above, the stub pattern 1100f may include the first stub pattern 1110f arranged between the first and second antenna elements 1110 and 1120 to the seventh stub pattern 1170f arranged between the seventh and eighth antenna elements 1170 and 1180. Each of the first stub pattern 1110f to the seventh stub pattern 1170f may be implemented to include the horizontal stub pattern HST and the vertical stub pattern VST.

Meanwhile, in the antenna module having a phase delay according to this specification, the feeding structures may be implemented as a plurality of stub patterns. By applying the slow-wave structure proposed in this specification to a design of a series-fed array antenna, a phase of a signal applied to an array element may be controlled while a gap between array antenna elements is maintained. This may allow to improve a beam-shift shape and design an array antenna to steer in a particular direction. In addition, by setting sizes of apertures of the array antenna to be different, beam-steering and forming performance that is difficult to design with general series-fed array antennas, such as varying a beam width, may be implemented.

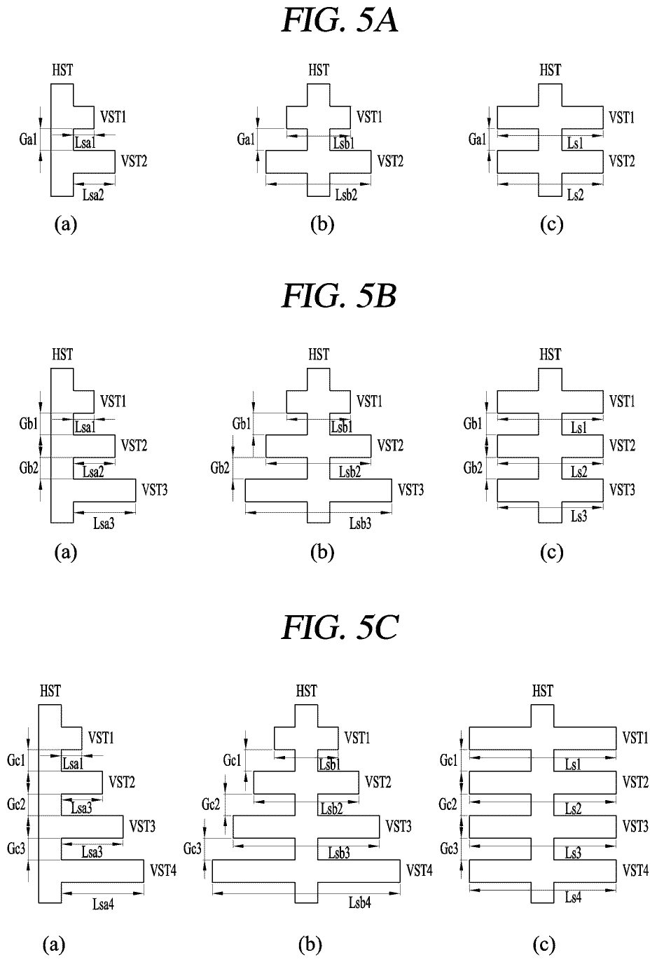

In this regard, FIGS. 5A to 5C illustrate feeding structures including a vertical stub pattern according to embodiments. Referring to FIGS. 5A to 5C, various design shapes of the slow-wave structure proposed in this specification are illustrated.

Meanwhile, the slow-wave structure may be implemented by a plurality of vertical stub patterns VST having multiple stages. As a number of the multiple stages increases, a phase delay effect of the feeding structures improves. Additionally, when one side and another side has a symmetrical structure, a phase delay effect of wideband feeding structures improves. Additionally, compared to a gradual type in which lengths of stub patterns increase, a phase delay effect of feeding structures is improved in a uniform type. Additionally, when stub patterns have great lengths, a phase delay effect of feeding structures improves. Meanwhile, the gradual type has improved impedance matching characteristics at wideband frequencies compared to the uniform type.

The vertical stub pattern VST may include a plurality of sub-patterns. Referring to FIGS. 3 and 5A, the vertical stub pattern VST may be configured to include a first sub-pattern VST1 and a second sub-pattern VST2. The first sub-pattern VST1 may be arranged at a first point of the horizontal stub pattern HST to have a first length Lsa1, Lsb1, or Ls1 in at least one direction among upper and lower directions on the another axis. In this regard, the upper direction on the another axis may correspond to an upper direction on the Y-axis. The lower direction on the another axis may correspond to a lower direction on the Y axis.

The second sub-pattern VST2 may be arranged at a second point of the horizontal stub pattern HST to have a second length Lsa2, Lsb2, or Ls2 to be parallel to the first sub-pattern VST1. The second sub-pattern VST2 may be arranged at the second point of the horizontal stub pattern HST to have the second length Lsa2, Lsb2, or Ls2 in at least one direction among the upper and lower directions on the another axis. In this regard, the upper direction on the another axis may correspond to the upper direction on the Y-axis. The lower direction on the another axis may correspond to the lower direction on the Y axis.

Referring to (a) of FIG. 5A, the vertical stub pattern VST may be arranged in either the upper direction or the lower direction on the another axis. Therefore, the vertical stub pattern VST may be implemented to have an asymmetric structure. In this regard, the first sub-pattern VST1 and the second sub-pattern VST2 may be arranged in either the upper direction or the lower direction on the another axis. The second length Lsa2 of the second sub-pattern VST2 may be greater than the first length Lsa1 of the first sub-pattern VST1.

Meanwhile, the vertical stub pattern VST may also be implemented to have a symmetric structure. Referring to (b) of FIG. 5A, the first sub-pattern VST1 and the second sub-pattern VST2 may be each arranged in the upper and lower directions on the another axis. In this regard, the second length Lsb2 of the second sub-pattern VST2 may be greater than the first length Lsb1 of the first sub-pattern VST1.

Referring to (c) of FIG. 5A, the first sub-pattern VST1 and the second sub-pattern VST2 may be each arranged in the upper and lower directions on the another axis. In this regard, the second length Ls2 of the second sub-pattern VST2 may be equal to the first length Ls1 of the first sub-pattern VST1.

Referring to FIGS. 3 and 5B, the vertical stub pattern VST may be configured to include the first sub-pattern VST1, the second sub-pattern VST2, and a third sub-pattern VST3. The first sub-pattern VST1 may be arranged at the first point of the horizontal stub pattern HST to have the first length Lsa1, Lsb1, or Ls1 in at least one direction among the upper and lower directions on the another axis. The second sub-pattern VST2 may be arranged at the second point of the horizontal stub pattern HST to have the second length Lsa2, Lsb2, or Ls2 to be parallel to the first sub-pattern VST1. The third sub-pattern VST3 may be arranged at a third point of the horizontal stub pattern HST to have a third length Lsa3, Lsb3, or Ls3 to be parallel to the first and second sub-patterns VST1 and VST2. The third length Lsa3, Lsb3, or Lsb3 of the third sub-pattern VST3 may be equal to or greater than the second length Lsa2, Lsb2, or Ls2 of the second sub-pattern VST2.

Referring to (a) of FIG. 5B, the vertical stub pattern VST may be arranged in either the upper direction or the lower direction on the another axis. Therefore, the vertical stub pattern VST may be implemented to have an asymmetric structure. In this regard, the first sub-pattern VST1, the second sub-pattern VST2, and the third sub-pattern VST3 may be arranged in either the upper direction or the lower direction on the another axis. The second length Lsa2 of the second sub-pattern VST2 may be greater than the first length Lsa1 of the first sub-pattern VST1. The third length Lsa3 of the third sub-pattern VST3 may be greater than the second length Lsa2 of the second sub-pattern VST2.

Meanwhile, the vertical stub pattern VST may also be implemented to have a symmetric structure. Referring to (b) of FIG. 5B, the first sub-pattern VST1, the second sub-pattern VST2, and the third sub-pattern VST3 may be each arranged in the upper and lower directions on the another axis. In this regard, the second length Lsb2 of the second sub-pattern VST2 may be greater than the first length Lsb1 of the first sub-pattern VST1. The third length Lsb3 of the third sub-pattern VST3 may be greater than the second length Lsb2 of the second sub-pattern VST2.

Referring to (c) of FIG. 5B, the first sub-pattern VST1, the second sub-pattern VST2, and the third sub-pattern VST3 may be each arranged in the upper and lower directions on the another axis. In this regard, the second length Ls2 of the second sub-pattern VST2 may be equal to the first length Ls1 of the first sub-pattern VST1. The third length Ls3 of the third sub-pattern VST3 may be equal to the second length Ls2 of the second sub-pattern VST2.

Referring to FIGS. 3 and 5C, the vertical stub pattern VST may be configured to include the first sub-pattern VST1, the second sub-pattern VST2, the third sub-pattern VST3, and a fourth sub-pattern VST4. The first sub-pattern VST1 may be arranged at the first point of the horizontal stub pattern HST to have a first length Lsa1, Lsb1, or Ls1 in at least one direction among the upper and lower directions on the another axis. The second sub-pattern VST2 may be arranged at the second point of the horizontal stub pattern HST to have a second length Lsa2, Lsb2, or Ls2 to be parallel to the first sub-pattern VST1. The third sub-pattern VST3 may be arranged at the third point of the horizontal stub pattern HST to have a third length Lsa3, Lsb3, or Ls3 to be parallel to the first and second sub-patterns VST1 and VST2. The fourth sub-pattern VST4 may be arranged at a fourth point of the horizontal stub pattern HST to have a fourth length Lsa4, Lsb4, or Ls4 to be parallel to the first to third sub-patterns VST1, VST2, and VST3. A third length Lsa4, Lsb4, Lsb4 of the fourth sub-pattern VST4 may be equal to or greater than the third length Lsa3, Lsb3, or Ls3 of the third sub-pattern VST3.

Referring to (a) of FIG. 5C, the vertical stub pattern VST may be arranged in either the upper direction or the lower direction on the another axis. Therefore, the vertical stub pattern VST may be implemented to have an asymmetric structure. In this regard, the first sub-pattern VST1, the second sub-pattern VST2, the third sub-pattern VST3, and the fourth sub-pattern VST4 may be arranged in either the upper direction or the lower direction on the another axis. The second length Lsa2 of the second sub-pattern VST2 may be greater than the first length Lsa1 of the first sub-pattern VST1. The third length Lsa3 of the third sub-pattern VST3 may be greater than the second length Lsa2 of the second sub-pattern VST2. The fourth length Lsa4 of the fourth sub-pattern VST4 may be greater than the third length Lsa3 of the third sub-pattern VST3.

Meanwhile, the vertical stub pattern VST may also be implemented to have a symmetric structure. Referring to (b) of FIG. 5C, the first sub-pattern VST1, the second sub-pattern VST2, the third sub-pattern VST3, and the fourth sub-pattern VST4 may be each arranged in the upper and lower directions on the another axis. In this regard, the second length Lsb2 of the second sub-pattern VST2 may be greater than the first length Lsb1 of the first sub-pattern VST1. The third length Lsb3 of the third sub-pattern VST3 may be greater than the second length Lsb2 of the second sub-pattern VST2. The fourth length Lsb4 of the fourth sub-pattern VST4 may be greater than the third length Lsb3 of the third sub-pattern VST3.

Referring to (c) of FIG. 5C, the first sub-pattern VST1, the second sub-pattern VST2, and the third sub-pattern VST3 may be each arranged in the upper and lower directions on the another axis. In this regard, the second length Ls2 of the second sub-pattern VST2 may be equal to the first length Ls1 of the first sub-pattern VST1. The third length Ls3 of the third sub-pattern VST3 may be equal to the second length Ls2 of the second sub-pattern VST2. The fourth length Ls4 of the fourth sub-pattern VST4 may be equal to the third length Ls3 of the third sub-pattern VST3.

Meanwhile, gaps between sub-patterns in the vertical stub pattern of FIGS. 5A to 5C may be defined differently. In this regard, to arrange the stub pattern 1100f including a plurality of sub-patterns in regions between adjacent antenna elements, gaps between the sub-patterns and/or widths of the sub-patterns may be designed to decrease when a number of sub-patterns increases.

The first sub-pattern VST1 and the second sub-pattern VST2 each shown in FIG. 5A may be spaced apart from each other by a first gap Ga1. The first sub-pattern VST1 and the second sub-pattern VST2 each shown in FIG. 5B may be spaced apart from each other by a second gap Gb1. The second sub-pattern VST2 and the third sub-pattern VST3 may be spaced apart from each other by a third gap Gb3. The second gap Gb2 between the first sub-pattern VST1 and the second sub-pattern VST2 may be set to be identical to the third gap Gb3 between the second sub-pattern VST2 and the third sub-pattern VST3.

The second gap Gb1 between the first sub-pattern VST1 and the second sub-pattern VST2 each shown in FIG. 5B may be smaller than the first gap Ga1 between the first sub-pattern VST1 and the second sub-pattern VST2 each shown in FIG. 5A. The third gap Gb2 between the second sub-pattern VST2 and the third sub-pattern VST3 each shown in FIG. 5B may be smaller than the first gap Ga1 between the first sub-pattern VST1 and the second sub-pattern VST2 each shown in FIG. 5A. Meanwhile, a width of the first sub-pattern VST1 of FIG. 5B may be smaller than a width of the first sub-pattern VST1 of FIG. 5A. A width of the second sub-pattern VST2 of FIG. 5B may be smaller than a width of the second sub-pattern VST2 of FIG. 5A.

The first sub-pattern VST1 and the second sub-pattern VST2 each shown in FIG. 5C may be spaced apart from each other by a fourth gap Gc1. The first sub-pattern VST2 and the third sub-pattern VST3 may be spaced apart from each other by a fifth sub-pattern Gc2. The third sub-pattern VST3 and the fourth sub-pattern VST4 may be spaced apart from each other by a sixth gap Gc3. The fourth gap Gc1 between the first sub-pattern VST1 and the second sub-pattern VST2, the fifth gap Gc2 between the second sub-pattern VST2 and the third sub-pattern VST3, and the sixth gap Gc3 between the second sub-pattern VST2 and the third sub-pattern VST3 may be set to be identical to one another.

The fourth gap Gc1 between the first sub-pattern VST1 and the second sub-pattern VST2 each shown in FIG. 5C may be smaller than the second gap Gb1 between the first sub-pattern VST1 and the second sub-pattern VST2 each shown in FIG. 5B. The fifth gap Gc2 between the second sub-pattern VST2 and the third sub-pattern VST3 each shown in FIG. 5C may be smaller than the third gap Gb2 between the first sub-pattern VST2 and the second sub-pattern VST2 each shown in FIG. 5B. Meanwhile, a width of the first sub-pattern VST1 of FIG. 5C may be smaller than the width of the first sub-pattern VST1 of FIG. 5B. A width of the second sub-pattern VST2 of FIG. 5C may be smaller than the width of the second sub-pattern VST2 of FIG. 5B. A width of the third sub-pattern VST3 of FIG. 5C may be smaller than a width of the third sub-pattern VST3 of FIG. 5B.

Meanwhile, a length between adjacent sub-patterns in the feeding structure 1100f of the antenna module according to this specification may be implemented within a certain range. In this regard, the second length Lsa2, Lsb2, or Ls2 of the second sub-pattern VST2 may be equal to or greater than one time and smaller than or equal to 1.32 times the first length Lsa1, Lsb1, or Ls1 of the first sub-pattern VST1. Meanwhile, the third length Lsa3, Lsb3, or Ls3 of the third sub-pattern VST3 may be equal to or greater than one time and smaller than or equal to 1.32 times the second length Lsa2, Lsb2, or Ls2 of the second sub-pattern VST3. In addition, the fourth length Lsa4, Lsb4, or Ls4 of the fourth sub-pattern VST4 may be defined as equal to or greater than one time and smaller than or equal to 1.32 times the third length Lsa3, Lsb3, or Ls3 of the third sub-pattern VST3.

Meanwhile, a length of a longest sub-pattern in the feeding structure 1100f of the antenna module according to this specification may be implemented not to not to exceed a predetermined range greater than the length of the horizontal stub HST. In this regard, a length of a longest sub-pattern among sub-patterns of the vertical stub pattern VST may be less than or equal to 1.32 times the length of the horizontal stub pattern HST.

Referring to FIG. 5A, a length of a longest sub-pattern Lsa2, Lsb2, or Ls2 among sub-patterns of the vertical stub pattern VST may be smaller than or equal to 1.32 times a length of the horizontal stub pattern HST. Referring to FIG. 5B, a length of a longest sub-pattern Lsa3, Lsb3, or Ls3 among sub-patterns of the vertical stub pattern VST may be equal to or less than 1.32 times a length of the horizontal stub pattern HST. Referring to FIG. 5C, a length of a longest sub-pattern Lsa4, Lsb4, or Ls4 among sub-patterns of the vertical stub pattern VST may be smaller than or equal to 1.32 times the length of the horizontal stub pattern HST. Therefore, in a feeding structure having a phase delay, an increase/decrease rate of a length difference between vertical stub patterns at adjacent stages may be designed not to exceed 32%. When the increase/decrease rate of the length difference between the vertical stub patterns exceeds 32%, impedance matching characteristics may deteriorate.

Meanwhile, in the array antenna structure of the antenna module according to this specification, a gap between adjacent antenna elements may be implemented to be within a predetermined range. In this regard, the gap G1 between the first antenna element 1110 and the second antenna element 1120 may be equal to or greater than 0.8 times and less than or equal to 1.0 times a wavelength corresponding to an operating frequency of an RF signal.

An array antenna of the antenna module according to this specification may include a plurality of antenna elements, e.g., four, six, eight, ten, twelve, fourteen, or sixteen antenna elements. The plurality of antenna elements may include the first antenna element 1110 to the eighth antenna element 1180.

In the array antenna, the gap G1 between the second antenna element 1120 and the second antenna element 1130 may be equal to or greater than 0.8 times and less than or equal to 1.0 times a wavelength corresponding to an operating frequency of an RF signal. Similarly, the gap G1 between the seventh antenna element 1170 and the third antenna element 1180 may be equal to or greater than 0.8 times and less than or equal to 1.0 times a wavelength corresponding to an operating frequency of an RF signal.

The stub pattern 1100f may include the first stub pattern 1110f arranged between the first and second antenna elements 1110 and 1120 to the seventh stub pattern 1170f arranged between the seventh and eighth antenna elements 1170 and 1180. Each of the first stub pattern 1110f to the seventh stub pattern 1170f may be implemented to include the horizontal stub pattern HST and the vertical stub pattern VST.

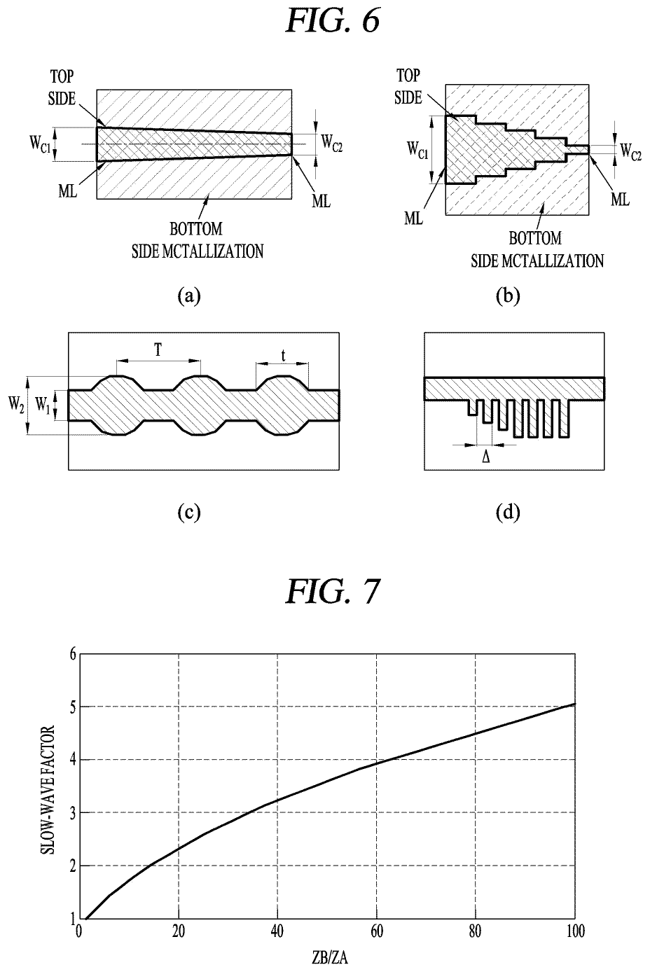

Meanwhile, a feeding structure of the antenna module having a phase delay according to this specification may be implemented as a slow-wave structure having a phase delay due to a variable dielectric substrate such as a liquid crystal layer. In this regard, FIG. 6 illustrates slow-wave structures according to embodiments. The slow-wave structures in (a) to (d) of FIG. 6 may be referred to as a tapered structure, a stepped structure, a meander structure, and a comb structure, respectively. Meanwhile, FIG. 7 shows slow-wave factors according to an impedance ratio in the slow-wave structure according to this specification.

Referring to FIGS. 3 to 6, a slow-wave structure may be implemented to delay a phase of a signal transmitted through a transmission line of the feeding structure 1100f. The slow-wave structure may be configured to delay a phase component of an output signal according to a slow-wave factor (SWF).

The feeding structure 1100f shown in each of FIGS. 5A to 5C may be implemented as a comb structure. The feeding structure 1100f having the comb structure has best performance in terms of impedance matching and symmetry compared to other structures. The slow-wave structure may include multiple stages having different impedances (Z) on a transmission line. The feeding structures of FIGS. 5A to 5C are structures in which two, three, and four stages are arranged, respectively.

As a structure arranged in a crossed or repetitive way, this structure may be equivalently interpreted as a structure in which impedance stages configured as a resistor-inductor-capacitor (RLC) circuit are connected to each other in series. At this time, to perform impedance matching of the entire transmission line, a geometric mean of impedances of all stages (for convenience of calculation, Z_{A} and Z_{B} (Z_{A}<Z₀<Z_{B}) in a case of two stages) needs to be equal to a characteristic impedance (Z0=50Ω) of an input and output transmission line. At this time, a slow-wave factor (SWF) may be determined from an impedance ratio (Z_{B}/Z_{A}) of each stage as expressed in Equation 1.

$$S W F = \frac{\sqrt{( {Z}_{A} / {Z}_{B} )} + \sqrt{( {Z}_{B} / {Z}_{A} )}}{2} \qquad [ Equation 1 ]$$

In the comb structure of (d) of FIG. 6, impedances between adjacent vertical line structures may be referred to as Z_{A} and Z_{B}, respectively. Referring to FIGS. 3 to 5C, (d) of FIG. 6, and FIG. 7, when a difference in a ratio (Z_{B}/Z_{A}) between the impedances of each stage is great, a slow-wave factor (SWF) becomes higher. Additionally, when the slow-wave factor (SWF) is high, a great phase delay occurs. As the great phase delay occurs, a great electrical length may be implemented within a limited region between adjacent antenna elements.

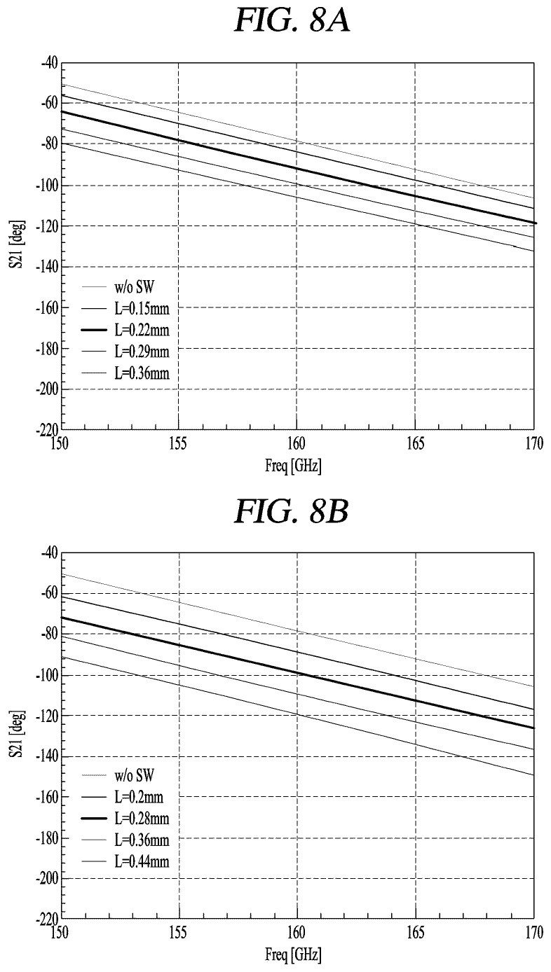

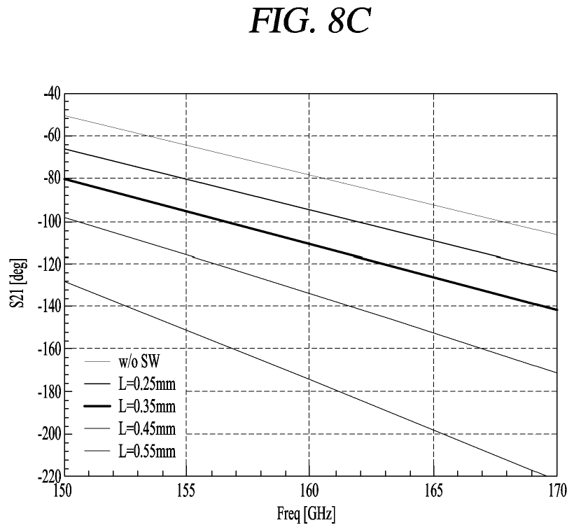

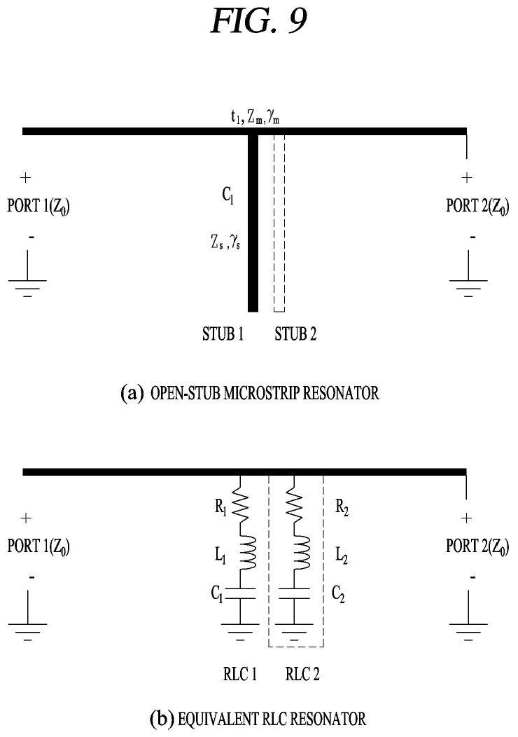

Meanwhile, the antenna module having a feeding structure according to this specification may be designed to have different phase delay characteristics when a length of a vertical stub pattern is changed. In this regard, FIGS. 8A to 8C show phase delay characteristics of a feeding structure depending on changes in a dielectric constant and a length of a longest vertical stub pattern according to embodiments. Meanwhile, FIG. 9 shows an equivalent circuit of a feeding structure including adjacent stub patterns of FIGS. 6A to 6C.

In a first structure having two vertical stub patterns of (b) of FIG. 6A, different phase delay characteristics may be implemented by changing a length of the second vertical stub pattern VST2. In a second structure having three vertical stub patterns of (b) of FIG. 6B, different phase delay characteristics may be implemented by changing a length of the third vertical stub pattern VST3. In a third structure having four vertical stub patterns of (b) of FIG. 6C, different phase delay characteristics may be implemented by changing a length of the fourth vertical stub pattern VST4.

Referring to (b) of FIG. 6A and FIG. 8A, the length Lsb2 of the second vertical stub pattern VST2 may be varied from 0.15 mm to 0.36 mm. As the length of the second vertical stub pattern VST2 of the feeding structure is increased, a phase delay value may be increased to thereby arrange antenna elements arranged to be closer to each other or expand a beam-forming range. As the length Lsb2 of the second vertical stub pattern VST2 is increased from 0.15 mm to 0.36 mm, a maximum phase shift may be 30 degrees.

Referring to (b) of FIG. 6B and FIG. 8B, the length Lsb3 of the third vertical stub pattern VST3 may be varied from 0.2 mm to 0.44 mm. As the length of the third vertical stub pattern VST3 of the feeding structure is increased, a phase delay value may be increased to thereby arrange antenna elements to be closer to each other or expand a beam-forming range. As the length Lsb3 of the third vertical stub pattern VST3 is increased from 0.2 mm up to 0.44 mm, a maximum phase shift may increase to 42 degrees.

Referring to (b) of FIG. 6B and FIG. 8B, the length Lsb4 of the fourth vertical stub pattern VST4 may be varied from 0.25 mm to 0.55 mm. As the length of the fourth vertical stub pattern VST4 of the feeding structure is increased, a phase delay value may be increased to thereby arrange antenna elements to be closer to each other or expand a beam-forming range. As the length Lsb4 of the fourth vertical stub pattern VST4 is increased from 0.25 mm up to 0.55 mm, a maximum phase shift may increase to 100 degrees.

(a) of FIG. 9 shows a feeding structure having adjacent vertical stub patterns as an equivalent circuit of an open-stub microstrip resonator. (b) of FIG. 9 shows a feeding structure having adjacent vertical stub patterns as an equivalent circuit of an RLC resonator.

Referring to FIGS. 6A to 6C and (a) of FIG. 9, one end and another end of the horizontal stub pattern HST may correspond to a first port Port 1 and a second port Port 2, respectively. An input impedance of the horizontal stub pattern HST is equal to Z₀. Depending on a line width of the horizontal stub pattern HST, an impedance may be expressed as Zₘ and a propagation constant as gₘ. Adjacent vertical stub patterns may correspond to first and second stubs Stub1 and Stub2, respectively. Depending on a line width of the first stub Stub1, an impedance may be expressed as Zs and a propagation constant may be expressed as gₛ.

Referring to FIGS. 6A to 6C and (b) of FIG. 9, one end and another end of the horizontal stub pattern HST may correspond to the first port Port 1 and the second port Port 2, respectively. An input impedance of the horizontal stub pattern HST is equal to Z₀. Depending on a line width of the horizontal stub pattern HST, an impedance may be expressed as Zₘ and a propagation constant as gₘ. Adjacent vertical stub patterns may correspond to the first and second stubs Stub1 and Stub2, respectively.

The first stub Stub1 may be configured to connect the first point of the horizontal stub pattern HST to the ground. The first stub Stub1 may be configured to include a first resistor R1, a first inductor L1, and a first capacitor C1. One end and another end of the first resistor R1 may be connected to the first point of the horizontal stub pattern HST and one end of the first inductor L1, respectively. The one end and another end of the first inductor L1 may be connected to the another end of the first resistor R1 and one end of the first capacitor C1, respectively. The one end and another end of the first capacitor C1 may be connected to the another end of the first inductor L1 and the ground, respectively.

The second stub Stub2 may be configured to include a second resistor R2, a second inductor L2, and a second capacitor C2. One end and another end of the second resistor R2 may be connected to the first point of the horizontal stub pattern HST and one end of the second inductor L2, respectively. The one end and the another end of the first inductor L1 may be connected to the another end of the second resistor R2 and one end of the second capacitor C2, respectively. The one end and another end of the second capacitor C2 may be connected to another end of the second inductor L2 and the ground, respectively.

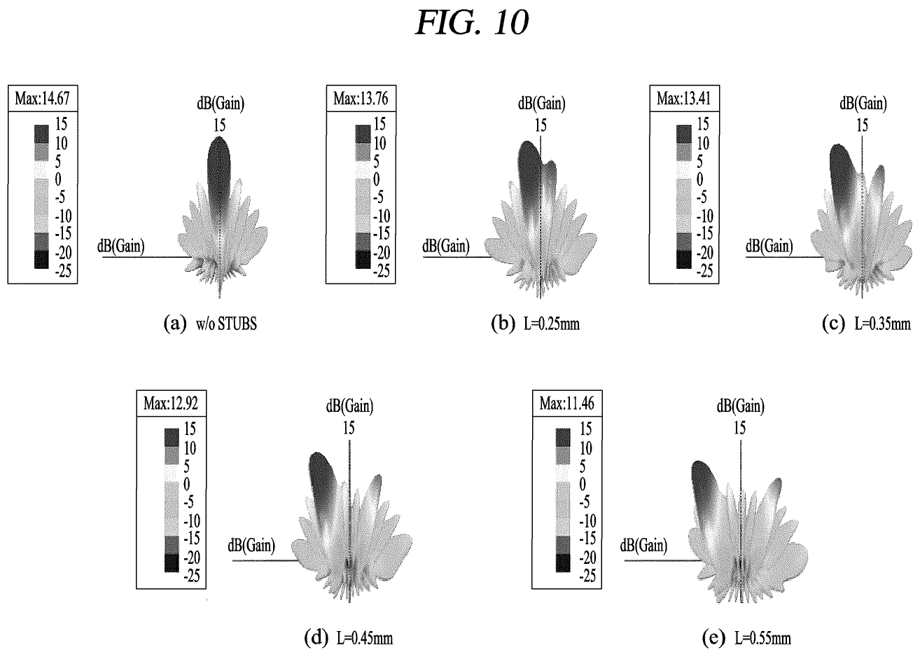

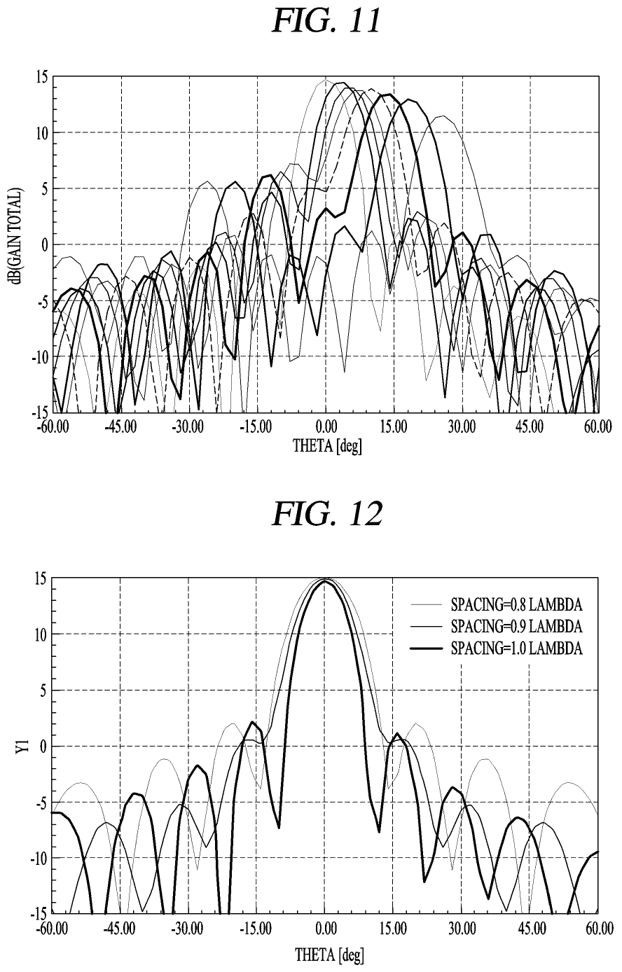

Meanwhile, in the antenna module having a phase delay according to this specification, a beamforming angle may be increased by increasing a length of a longest vertical stub pattern of a feeding structure. In this regard, FIG. 10 shows three-dimensional (3D) radiation patterns when a length of the fourth vertical stub pattern in the antenna module of FIG. 3 is changed. FIG. 11 shows two-dimensional (2D) radiation patterns when a length of the fourth vertical stub pattern in the antenna module of FIG. 3 is changed. The radiation patterns of FIGS. 10 and 11 represent radiation patterns of an array antenna in which a gap between adjacent antenna elements is equal to a wavelength.

Referring to FIG. 3, FIG. 5C, (a) of FIG. 10, and FIG. 11, in a structure having only the horizontal stub pattern HST without a vertical stub pattern, a beam direction angle is 0 degrees in an X-axis direction. An antenna gain at 0 degree in the X-axis direction is 14.67 dBi. Referring to FIG. 3, FIG. 5C, (b) of FIG. 10, and FIG. 11, when the length Lsb4 of the fourth vertical stub pattern VST4 is 0.25 mm, a beam direction angle is a first angle in the X-axis direction. An antenna gain at the first angle in the X-axis direction is 13.76 dBi. Referring to FIG. 3, FIG. 5C, (c) of FIG. 10, and FIG. 11, when the length Lsb4 of the fourth vertical stub pattern VST4 is 0.35 mm, a beam direction angle is a second angle greater than the first angle in the X-axis direction. An antenna gain at the second angle in the X-axis direction is 13.41 dBi.

Referring to FIG. 3, FIG. 5C, (d) of FIG. 10, and FIG. 11, when the length Lsb4 of the fourth vertical stub pattern VST4 is 0.45 mm, a beam direction angle is a third angle greater than the second angle in the X-axis direction. An antenna gain at the third angle in the X-axis direction is 12.92 dBi. Referring to FIG. 3, FIG. 5C, (e) of FIG. 10, and FIG. 11, when the length Lsb4 of the fourth vertical stub pattern VST4 is 0.55 mm, a beam direction angle is a fourth angle greater than the third angle in the X-axis direction. The fourth angle may be implemented to have a value equal to or greater than about 25 degrees. At the fourth angle in the X-axis direction, an antenna gain is 11.46 dBi, which is a gain value approximately 3 dBi lower than the antenna gain at 0 degrees. Therefore, the antenna module including a feeding structure having a phase delay according to this specification may implement a beamforming angle of 25 degrees or greater while maintaining a reduction in an antenna gain by about 3 dBi.

Meanwhile, FIG. 12 shows 2D radiation patterns according to changes in a gap between adjacent antenna elements in the antenna module of FIG. 3. Referring to FIG. 12, radiation patterns when a gap between adjacent antenna elements corresponds to 0.8 wavelength, 0.9 wavelength, and one wavelength, respectively, are shown. Referring to FIG. 3 and FIG. 12, an antenna radiation pattern at 160 GHz in a 1×8 array antenna having eight antenna elements is shown. In an array antenna to which a feeding structure having the slow-wave structure is applied, as a gap between adjacent antenna elements is changed to 0.8 wavelength, 0.9 wavelength, and one wavelength, a 3 dB beam width decreases to 13.6 degrees, 11.4 degrees, and 9.0 degrees, respectively. As a gap between adjacent antenna elements increases to 0.8 wavelength, 0.9 wavelength, and one wavelength, respectively, the 3 dB beamwidth may decrease, thereby improving beamforming resolution performance.

The antenna module having a phase delay according to this specification has been described above. Hereinafter, technical effects of the antenna module having a phase delay according to this specification are described.

According to an embodiment, two-dimensional beam-steering of an array antenna may be performed by applying a slow-wave structure and a liquid crystal medium to a design of a series-fed array antenna.

According to an embodiment, a signal transmission phase may be actively controlled by implementing a phase shift circuit based on a slow-wave structure in a series-fed array antenna, using a liquid crystal layer, and changing a parameter of a phase delay circuit.

According to an embodiment, a feed loss in a millimeter wave band may be reduced by implementing feeding lines between antenna elements as a serial feeding structure having a slow-wave structure.

According to an embodiment, wireless communication performance may be improved in frequency bands at or above millimeter wave bands by generating a directional beam in a desired direction along one axis direction through a one-dimensional array antenna structure having serial feeding lines.

Further scope of applicability of this specification will become apparent from the following detailed description. It should be understood, however, that the detailed description and specific examples, such as the exemplary embodiment of this specification, are given by way of illustration only, since various changes and modifications within the idea and scope of this specification will be apparent to those skilled in the art. The detailed description should not be limitedly construed in all of the aspects, and should be understood to be illustrative. The scope of this specification should be determined by reasonable interpretation of the appended claims, and all changes within the scope of equivalents of this specification are included in the scope of this specification.

1. An antenna module comprising:
a dielectric substrate;
a plurality of antenna elements arranged on one surface of the dielectric substrate in a direction of one axis, the plurality of antenna elements comprising a first antenna element and a second antenna element arranged to face each other;
a stub pattern configured to connect side surfaces of the first antenna element and the second antenna element in the one axis direction, the side surfaces facing each other; and
a liquid crystal layer arranged in a region below the stub pattern,
wherein the stub pattern comprises:
a horizontal stub pattern configured to connect the facing side surfaces of the first antenna element and the second antenna element in the one axis direction; and
vertical stub patterns arranged to extend from different points on the horizontal stub pattern in a direction of another axis to be perpendicular to the horizontal stub pattern.

2. The antenna module of claim 1, further comprising a feeding line connected to one side of an outermost element among the plurality of antenna elements, and configured such that a radio frequency (RF) element is applied to the outermost element,
wherein an RF signal applied through the feeding line is transmitted to the second antenna element through the first antenna element and the stub pattern.

3. The antenna module of claim 1, wherein the vertical stub patterns comprise:
a first sub-pattern arranged at a first point of the horizontal stub pattern to have a first length in at least one direction among an upper direction and a lower direction on the another axis;
a second sub-pattern arranged at a second point of the horizontal stub pattern to have a second length to be parallel to the first sub-pattern,
wherein the first sub-pattern is arranged to be adjacent to the first antenna element, and the second sub-pattern is arranged to be adjacent to the second antenna element.

4. The antenna module of claim 3, wherein the first sub-pattern and the second sub-pattern are arranged in either the upper direction or the lower direction on the another axis, and
the second length of the second sub-pattern is greater than the first length of the first sub-pattern.

5. The antenna module of claim 3, wherein the first sub-pattern and the second sub-pattern are each arranged in the upper direction and the lower direction on the another axis, and
the second length of the second sub-pattern is greater than the first length of the first sub-pattern.

6. The antenna module of claim 3, wherein the first sub-pattern and the second sub-pattern are each arranged in the upper direction and the lower direction on the another axis, and
the second length of the second sub-pattern is equal to the first length of the first sub-pattern.

7. The antenna module of claim 3, wherein the vertical stub patterns further comprise a third sub-pattern arranged at a third point of the horizontal stub pattern and having a third length to be parallel to the first sub-pattern and the second sub-pattern,
wherein the third length of the third sub-pattern is equal to or greater than the second length of the second sub-pattern.

8. The antenna module of claim 7, wherein the first sub-pattern, the second sub-pattern, and the third sub-pattern are arranged in either an upper region or a lower region on the another axis,
the third length of the third sub pattern is greater than the second length, and
the second length of the second sub-pattern is greater than the first length.

9. The antenna module of claim 7, wherein the first sub-pattern, the second sub-pattern, and the third sub-pattern are each arranged in the upper direction and the lower direction on the another axis,
the second length of the second sub-pattern is greater than the first length of the first sub-pattern, and
the third length of the third sub-pattern is greater than the second length of the second sub-pattern.

10. The antenna module of claim 7, wherein the first sub-pattern, the second sub-pattern, and the third sub-pattern are each arranged in the upper direction and the lower direction on the another axis,
the second length of the second sub-pattern is equal to the first length of the first sub-pattern, and
the third length of the third sub-pattern is equal to the second length of the second sub-pattern.

11. The antenna module of claim 7, wherein the vertical stub patterns further comprise a fourth sub-pattern arranged at a fourth point of the horizontal stub pattern and having a fourth length to be parallel to the first sub-pattern to the third sub-pattern,
wherein the fourth length of the fourth sub-pattern is equal to or greater than the third length of the third sub-pattern.

12. The antenna module of claim 11, wherein the first sub-pattern, the second sub-pattern, the third sub-pattern, and the fourth sub-pattern are arranged in either an upper region or a lower region on the another axis,
the fourth length of the fourth sub pattern is greater than the third length,
the third length of the third sub pattern is greater than the second length, and
the second length of the second sub-pattern is greater than the first length.

13. The antenna module of claim 11, wherein the first sub-pattern, the second sub-pattern, the third sub-pattern, and the fourth sub-pattern are each arranged in the upper direction and the lower direction on the another axis,
the second length of the second sub-pattern is greater than the first length of the first sub-pattern,
the third length of the third sub-pattern is greater than the second length of the second sub-pattern, and
the fourth length of the fourth sub-pattern is greater than the third length of the third sub-pattern.

14. The antenna module of claim 11, wherein the first sub-pattern, the second sub-pattern, the third sub-pattern, and the fourth sub-pattern are each arranged in the upper direction and the lower direction on the another axis,
the second length of the second sub-pattern is equal to the first length of the first sub-pattern,
the third length of the third sub-pattern is equal to the second length of the second sub-pattern, and
the third length of the fourth sub-pattern is equal to the second length of the fourth sub-pattern.

15. The antenna module of claim 11, wherein the second length of the second sub-pattern is equal to or greater than one time and less than or equal to 1.32 times the first length of the first sub-pattern,
the third length of the third sub-pattern is equal to or greater than one time and less than or equal to 1.32 times the second length of the second sub-pattern, and
the fourth length of the fourth sub-pattern is equal to or greater than one time and less than or equal to 1.32 times the third length of the third sub-pattern.
